(19) United States
(12) Patent Application Publication
(10) Pub. No.: US 2005/0173405 A1
(43) Pub. Date: Aug. 11, 2005

(54) Brazing unit

(75) Inventor: Toshihiko Ikoma, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/028,326

(22) Filed: Jan. 4, 2005

(30) Foreign Application Priority Data
Jan. 22, 2004 (JP) 2004-014010

(51) Int. Cl. H05B 3/02

(52) U.S. Cl. 219/482

(57) ABSTRACT

A load sensor is joined to an axle of a vehicle by melting a brazing wire with a brazing unit. The brazing unit has a current variable part to vary the current flow to the brazing wire and a controller to control the current variable part. Thereby, the desired joint strength is attained, and shrinkage cracks of the brazing portion or heat cracks in a hardening layer (heat influenced part) of a member to be joined is prevented.

### BACKGROUND OF THE INVENTION

1. Field of the Invention

The present invention relates to a brazing unit and more particularly to a brazing unit which is suitable to attach a load sensor to the axle of a vehicle.

2. Related Art

A load measurement is usually performed by a load sensor for large-sized vehicles, such as a track, to prevent overloading. The load sensor is attached to the axle of a vehicle wheel by a welding and the like. When the axle receives a load by an overloading, it generates a distortion and the overloading value is measured by detecting the distortion.

FIG. 3 illustrates an attachment of the conventional load sensor. In FIG. 3, the load sensor 3 is disposed on the axle 1 of the vehicle wheel 2 as shown by a dashed line and a fixing 3a piece is joined to the axle 1.

The load sensor 3 is attached to the axle of the front and rear wheel in the case of a track. When the durability and the accuracy of the load sensor are taken into consideration, a welding is suitable for the attachment. Although arc welding can be considered as the most general welding method, it should not cause any damage or deformation to the axle since the axle is a part of run.

However, when a load sensor is attached on the surface of the axle by an arc welding, the axle, which is the base material of the arc welding, melts and may hollow from the original surface. In this case, a crater process to return the original surface is performed. Moreover, since many of axles are using high carbon steel with high hardening property, the arc welding forms a hardening layer (or called a heat influenced part) in the attachment place of the load sensor.

Consequently, the hardening layer (heat influenced part) becomes a cause which reduces the strength of the axle. When, the region spreads, the axle may break since the axle is a member to which the vehicle weight intensively is applied.

Then, a brazing method can be considered as a method of welding without melting the axle of the base material. There is a method called MIG brazing which utilizes, for example, a copper(Cu)-silicon(Si)-manganese(Mn) wire.

MIG brazing utilizing Cu—Si—Mn wire is generally used. However, there is no example to be used in a point shape with a short time such as the attachment of a load sensor, and shrinkage cracks occur at a bead top due to a rapid cooling.

FIGS. 4-7 illustrate an attachment of a load sensor by means of the MIG brazing method.

FIGS. 4 and 5 show a current waveform and a welded state by a brazing method, respectively when a high current with a long time is applied to Cu—Si—Mn wire. When a high current (I1) and a long brazing time (T1=t1−t0) are applied, a hardening layer (heat influenced part) 1a occurs at the surface of an axle 1 where a bead-like brazing portion 4 is formed, and a heat crack 5 is generated wherein. The heat crack 5 results in the breakage of the axle 1.

FIGS. 6 and 7 show a current waveform and a welded state by a brazing method, respectively when a lower current with a shorter time is applied to Cu—Si—Mn wire compared to the case of FIG. 4. When a current (I2) is relatively low (namely, I1>I2) and a brazing time (T2=t2−t0) is relatively short (namely, T1>T2), the range of the hardening layer (heat influenced part) 1a produced on the surface of the axle 1 becomes comparatively narrow and the heat crack does not occur.

However, in this case, the shrinkage crack 4a occurs at the bead top in the brazing portion 4 resulting in that the bonding strength of the load sensor 3 is not assured. If the shrinkage crack 4a of the bead top-reaches to the hardening layer 1a of the axle 1, the axle 1 may cause a breakage.

### SUMMARY OF THE INVENTION

An object of the present invention is to provide a brazing unit which prevents heat cracks or shrinkage cracks to assure a joint strength.

According to the invention of claim 1, a brazing unit for joining a join member to a member to be joined by melting a brazing wire includes a current variable part for varying the current flowing the brazing wire in energizing state and a controller to control the current variable part.

Thereby, a desired joint strength is attained, and shrinkage cracks of a brazing portion or heat cracks in a hardening layer (heat influenced part) of a member to be joined is prevented.

Preferably, in the brazing unit according to claim 1, the controller controls the current variable part to vary from a maximum current which is a lowest current to attain a desired joint strength to a minimum current which is a lowest current for discharging an arc stably from the brazing wire.

Thereby, the desired joint strength is attained, and the shrinkage crack of the brazing portion or the heat cracks in the hardening layer (heat influenced part) of the member to be joined is prevented.

Preferably, in the brazing unit according to claim 2, the controller controls the current variable part to vary continuously from the maximum current to the minimum current.

Thereby, the desired joint strength is attained, and the shrinkage crack of the brazing portion or the heat crack in the hardening layer (heat influenced part) of the member to be joined is prevented.

Preferably, in the brazing unit according to claim 2, the controller controls the current variable part to vary from the maximum current to the minimum current with steps.

Thereby, the desired joint strength is attained, and the shrinkage crack of the brazing portion or the heat crack in the hardening layer (heat influenced part) of the member to be joined is prevented.

Preferably, in the brazing unit according to claim 4, the controller controls the current variable part to vary with steps from the maximum current, through a intermediate current, to the minimum current.

Thereby, the desired joint strength is attained, and the shrinkage crack of the brazing portion or the heat crack in the hardening layer (heat influenced part) of the member to be joined is prevented.

Preferably, in the brazing unit according to any one of claims 1-5, the member to be joined is an axle of a vehicle and the join member is a load sensor.

Thereby, the desired joint strength is attained, and the shrinkage crack of the brazing portion or the heat crack in the hardening layer (heat influenced part) of the member to be joined is prevented.

### BRIEF DESCRIPTION OF THE DRAWINGS

FIG. 1A is a block diagram showing an embodiment according to the present invention of a brazing unit;

FIG. 1B is a current waveform showing an embodiment according to the present invention of a brazing unit;

FIG. 2 shows a welded state after brazing by means of the brazing unit of FIG. 1;

FIG. 3 illustrates a conventional attachment of a load sensor;

FIG. 4 is a current waveform of a brazing with a high current supplied to a Cu—Si—Mn wire and a long time brazing;

FIG. 5 is a welded state of a brazing with a high current supplied to a Cu—Si—Mn wire and a long time brazing;

FIG. 6 is a current waveform of a brazing with a lower current supplied to a Cu—Si—Mn wire and a shorter time, than FIG. 4;

FIG. 7A is a sectional view showing a welded state of a brazing with a lower current supplied to a Cu—Si—Mn wire and a shorter time, than FIG. 4; and

FIG. 7B is a plan view showing a welded state of a brazing with a lower current supplied to a Cu—Si—Mn wire and a shorter time, than FIG. 4.

### DETAILED DESCRIPTION OF THE PREFERED EMBODIMENTS

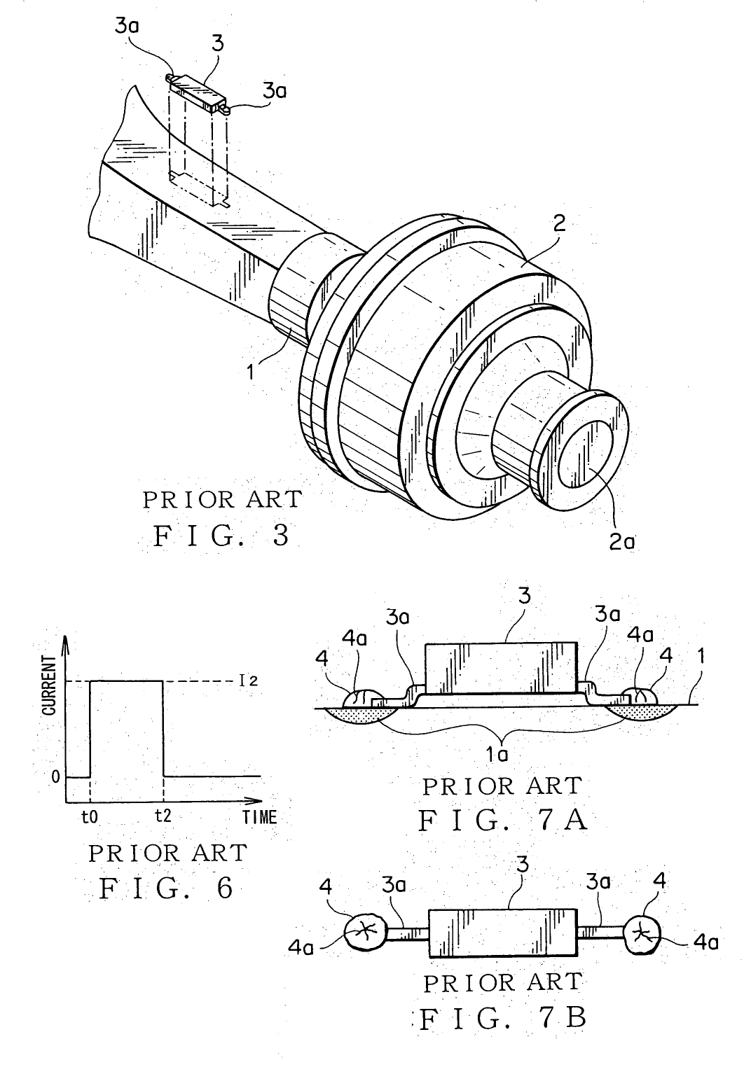

Embodiments of a brazing unit according to the present invention are illustrated referring to drawings. FIG. 1A is a construction showing an embodiment of a brazing unit according to the present invention and FIG. 1B is a current waveform thereof. In FIGS. 1A and 1B, the same constituting elements as in FIGS. 3-5 utilize the same numerals in FIG. 3-5.

In FIG. 1A, a load sensor 3 is disposed on the surface of an axle 1 and a fixing piece 3a contacts the surface of the axle 1. A tapered nozzle 6 guides a Cu—Si—Mn wire 7 to the joining place between the fixing piece 3a of the load sensor 3 and the surface of the axle 1. The Cu—Si—Mn wire 7 is connected to a positive terminal (or a negative terminal) of a direct-current power supply 8. The negative terminal (or positive terminal) of the direct-current power supply 8 is connected to the axle 1 through a current variable part 9. The current variable part 9 varies the current which flows the direct-current power supply 8, by the control of a controller 10.

When the Cu—Si—Mn wire guided through the nozzle 6 supplied from a wire supplier (not shown) contacts a fixing piece 3a, the current circuit of the direct-current power supply 8 is closed and energized, and when departing from the fixing piece 3a, the circuit is opened and is not energized.

As shown in FIG. 1B, the brazing unit of the present invention controls the electric current of the brazing with steps so as to avoid the shrinkage crack of the bead top and the heat crack of the hardening layer (heat influenced part) in the axle, and assure the joint strength of the brazing portion.

The current circuit of the direct-current power supply 8 is closed and energized, and the current variable part 9 is controlled by the controller 10. A maximum current (I3) is first applied for a suitable time (T3=t3−t0) and the wettability of the brazing material (Cu—Si—Mn wire 7) to the axle is assured. The maximum current (I3) is the lowest current value enough to accomplish a desired joint strength.

Next, by controlling the current variable part 9 with the controller 10, a current (I4) lower than the maximum current (I3) is applied for a suitable time (T4=t4−t3), a minimum current (I5) lower than the current (I4) is applied for a suitable time (T5=t5−t4) and the current is gradually decreased to prevent the shrinkage crack of the bead top. The minimum current (I5) is the lowest current value to keep the arc stable at the tip of the Cu—Si—Mn wire 7.

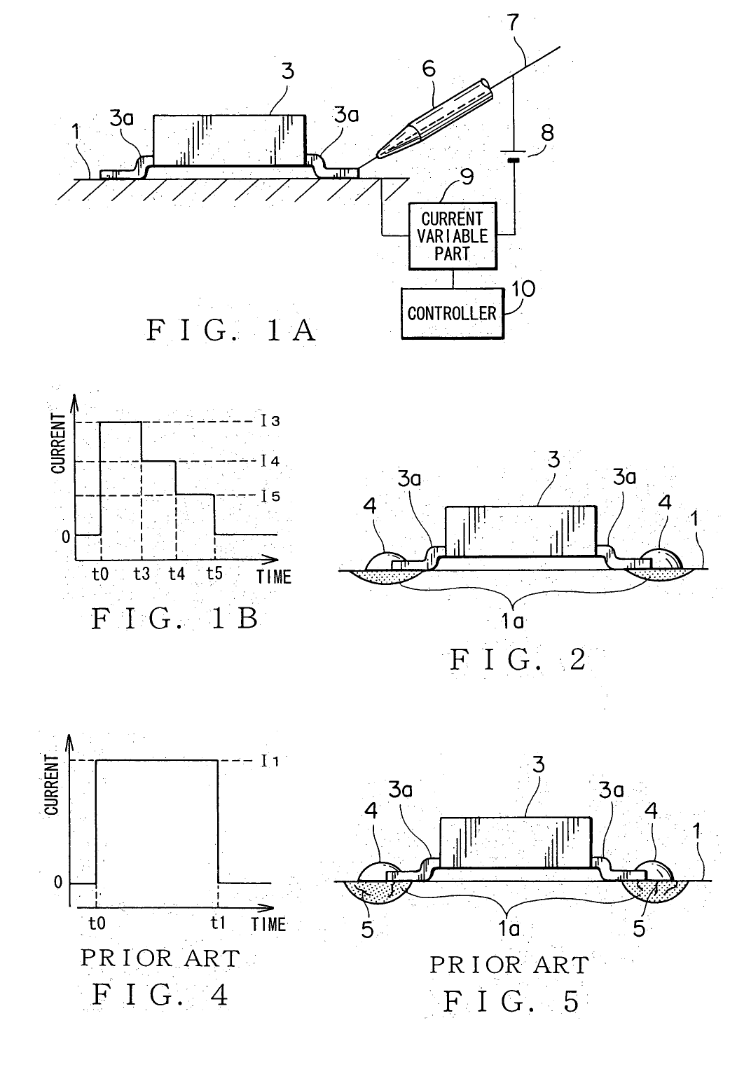

Thus, by controlling the current value of the brazing with the steps, the arc discharges stably from the tip of the Cu—Si—Mn wire 7 to the fixing piece 3a in energizing, the tip of the Cu—Si—Mn wire 7 melts with the Joule heat, and as shown in FIG. 2, the brazing portion 4 is formed. Whenever the current is changed in steps, the brazing filler metal is supplied to the brazing portion 4 so that the shrinkage crack at the bead top thereof is prevented. Moreover, the region of the hardening layer (heat influenced part) 1a in the axle 1 becomes relatively narrow and the heat crack is not generated so as to assure the desired joint strength.

Although the embodiments of the present invention are described, all variations thereof are intended to be embraced therein.

The embodiments change the electric current with three steps. However, for example, the current may be changed with two steps, four or more steps or continuously.

The embodiments describe the brazing of the load sensor 3 to the surface of the axle 1. The present invention is not limited to but is also adapted to the brazing of a general join member and a member to be joined.

1. A brazing unit for joining a join member to a member to be joined by melting a brazing wire, comprising:
a current variable part for varying the current flowing the brazing wire in energizing state; and
a controller to control the current variable part.

2. The brazing unit according to claim 1, wherein the controller controls the current variable part to vary from a maximum current which is a lowest current to attain a desired joint strength to a minimum current which is a lowest current for discharging an arc stably from the brazing wire.

3. The brazing unit according to claim 2, wherein the controller controls the current variable part to vary continuously from the maximum current to the minimum current.

4. The brazing unit according to claim 2, wherein the controller controls the current variable part to vary from the maximum current to the minimum current with steps.

5. The brazing unit according to claim 4, wherein the controller controls the current variable part to vary with steps from the maximum current, through a intermediate current, to the minimum current.

6. The brazing unit according to claim 1, wherein the member to be joined is an axle of a vehicle and the join member is a load sensor.

7. The brazing unit according to claim 2, wherein the member to be joined is an axle of a vehicle and the join member is a load sensor.

8. The brazing unit according to claim 3, wherein the member to be joined is an axle of a vehicle and the join member is a load sensor.

9. The brazing unit according to claim 4, wherein the member to be joined is an axle of a vehicle and the join member is a load sensor.

10. The brazing unit according to claim 5, wherein the member to be joined is an axle of a vehicle and the join member is a load sensor.
